(19) United States
(12) Patent Application Publication
(10) Pub. No.: US 2017/0064539 A1
(43) Pub. Date: Mar. 2, 2017

(54) ELECTRONIC DEVICE AND METHOD FOR REGISTERING DIFFERENT NETWORKS USING THE ELECTRONIC DEVICE

(71) Applicant: Chiun Mai Communication Systems, Inc., New Taipei (TW)

(72) Inventor: LING YANG, New Taipei (TW)

(21) Appl. No.: 15/047,053

(22) Filed: Feb. 18, 2016

(30) Foreign Application Priority Data
Aug. 27, 2015 (CN) 201510536571.1

(51) Int. Cl. H04W 8/04; H04W 64/00; H04W 8/12

(52) U.S. Cl. CPC H04W 8/04; H04W 8/12; H04W 64/00; H04W 88/06

(57) ABSTRACT

A method for registering on a network by using multiple radio access technologies using an electronic device includes acquiring first user information when receiving a first location update request from a first client device. The first location update request is in response to a first attach request from a user equipment. The first user information is stored into the storage device. Second user information is acquired by the electronic device when receiving a second location update request from a second client device. The second location update request is in response to a second attach request from the user equipment. The second user information is stored into a storage device if an IMSI of the second user information is different from an IMSI of the first user information.

### CROSS-REFERENCE TO RELATED APPLICATIONS

This application claims priority to Chinese Patent Application No. 201510536571.1 filed on Aug. 27, 2015, the contents of which are incorporated by reference herein.

### FIELD

The subject matter herein generally relates to communication technologies.

### BACKGROUND

In order to satisfy growing demands for communications, a multi-mode terminal technology, capable of supporting two or more types of modes at the same, has been developed so far. In the multi-mode terminal technology, a multi-mode single Subscriber Identity Module (SIM) card dual-standby terminal device can reside in two different communication subsystems. One of the subsystems can be Long-Term Evolution (LTE) communication system, the other one of the subsystems can be 2G/3G communication system. However, if the multi-mode single SIM card dual-standby terminal device registers network using different wireless access technologies at the same time, a ping-pong effect will occur.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of a communication system.

FIG. 2 is a block diagram of an example embodiment of user information.

FIG. 3 is a flowchart of an example embodiment of a method for registering network.

FIG. 4 is a block diagram of an example embodiment of an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

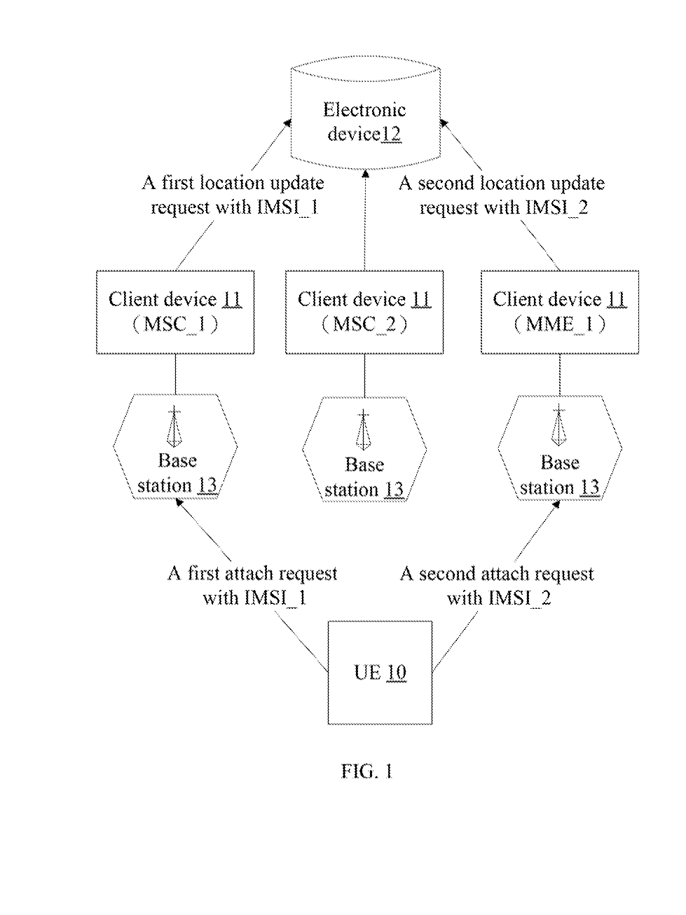

FIG. 1 is a block diagram of an example embodiment of a communication system. In at least one embodiment as shown in FIG. 1, the communication system 1 includes, but is not limited to, User Equipment (UE) 10, at least one client device 11, an electronic device 12, and a base station 13. The client device 11 and the electronic device 12 are core network devices. The base station 13 can communicate with the client device 11, and the client device 11 can communicate with the electronic device 12. In at least one embodiment, the electronic device 12 can be a user data device, and the electronic device 12 can provide support to an entity of the communication system 1 to manage calls. For example, the electronic device 12 can access to user profiles, be responsible for the authentication and authorization of each user, and provide Internet Protocol (IP) address of the user. In at least one embodiment, the electronic device 12 includes, but is not limited to, a Home Location Register (HLR), a Home Subscriber Server (HSS), a storage device (not show in FIG. 1), and at least one processor (not show in FIG. 1). FIG. 1 illustrates only one example of the communication system, other examples can include more or fewer components than illustrated, or have a different configuration of the various components in other embodiments.

In at least one embodiment, the storage device can include various types of non-transitory computer-readable storage mediums. For example, the storage device can be an internal storage system, such as a flash memory, a random access memory (RAM) for temporary storage of information, and/or a read-only memory (ROM) for permanent storage of information. The storage device can also be an external storage system, such as a hard disk, a storage card, or a data storage medium. In at least one embodiment, the at least one processor can be a central processing unit (CPU), a microprocessor, or other data processor chip that performs functions of the electronic device 12.

In at least one embodiment, the UE 10 can send at least one attach request to the mobile manager device 11. In at least one embodiment, the client device 11 can be a mobile manage device. The client device 11 can be responsible for mobility management of a control plane of the communication system 1. The mobility management includes managing mobility management context and state, and assigning temporary identities for users. In at least one embodiment, the client device 11 can include a first client device and a second client device. The first client device can be a Mobile Switching Center (MSC), and the second client device can be a Mobile Management Entity (MME). The MSC and the MME can be one or more in the communication system 1. Only two of the MSC are shown in FIG. 1, for example, MSC_1 and MSC_2. Only one of the MME is shown in FIG. 1, for example, MME_1. In at least one embodiment, a service range of the MSC or the MME having one or more base station 13.

In at least one embodiment, the HLR and the HSS can be configured in a physical entity, such as an integrative HLR/HSS. The HLR and the HSS also can be configured in different physical entities, such as a non-integrative HLR/HSS. The HLR is a central database that contains information of each user, for example, subscription data and location information of each user. The HLR can be a part of the HSS, and can be applied in a traditional Circuit Switching (CS) domain and a Packet Switching (PS) domain. The CS domain can provide voice service, and supplementary service based on the voice service to the mobile user. For example, voice calls, text messages, and supplementary services. The PS domain can provide data services.

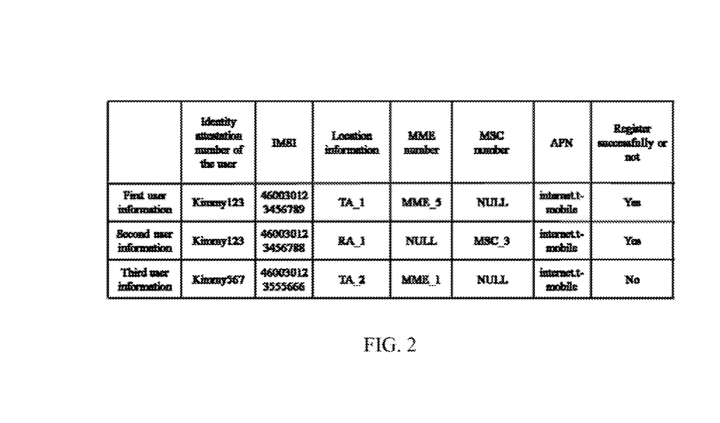

In at least one embodiment, when the UE 10 registers a network using different wireless access technologies at the same time, the client device 11 can receive an attach request from the UE 10. In at least one embodiment, the attach request can include an International Mobile Subscriber Identification (IMSI). For example, the first client device can receive a first attach request from the UE 10, the second client device can receive a second attach request from the UE 10. The electronic device 12 can acquire first user information by receiving a first location update request from the MSC, and store the first user information into the storage device for registering on a network by using the first user information. The electronic device 12 can acquire second user information by receiving a second location update request from the MME, and store the second user information into the storage device for registering network. As shown in FIG. 2, the user information can include, but not limit to, identity attestation number of the user, IMSI, location information, MME number, MSC number, and Access Point Name (APN). In at least one embodiment, the identity attestation number of the first user information can be the same as the second user information.

In at least one embodiment, the electronic device 12 can determine whether the IMSI of the second user information is the same as the IMSI of the first user information. If the IMSI of the second user information is the same as the IMSI of the first user information, the electronic device 12 can update the first user information to be the second user information. If the IMSI of the second user information is different from the IMSI of the first user information, the electronic device 12 can keep the first user information that is registered, and store the second user information into the storage device for registering the network again.

For example, in a system architecture of the integrated HLR/HSS, the MSC_1 can receive the first attach request for registering the 3G network from the UE 10, and the MME_1 can receive the second attach request for registering the 4G network from the UE 10. In at least one embodiment, the UE 10 can include two IMSI, for example, IMSI_1, and IMSI_2. The first attach request received by the MSC_1 can include the IMSI_1, and the second attach request received by the MME_1 can include the IMSI_2. The integrated HLR/HSS can acquire the first user information by receiving the first location update request from the MSC_1, and store the first user information into the storage device. The integrated HLR/HSS can acquire the second user information by receiving the second location update request from the MME_1, and store the second user information into the storage device. The integrated HLR/HSS can determine whether the IMSI of the second user information is the same as the IMSI of the first user information.

In at least one embodiment, if the IMSI of the second user information is the same as the IMSI of the first user information, the integrated HLR/HSS can update the first user information to be the second user information, and register the network using the second user information. In at least one embodiment, as shown in FIG. 1, if the UE 10 roams from a service range of the MSC_1 to a service range of the MSC_2, the location information of the second user information will be different from the location information of the first user information. Thus, the integrated HLR/HSS updates the first user information to be the second user information for registering the network. In detail, the integrated HLR/HSS can de-attach the IMSI of the first user information, and register the network using the second user information.

In at least one embodiment, if the IMSI of the second user information is different from the first user information, the integrated HLR/HSS can keep the first user information, and store the second user information for registering the network. Thus, the integrated HLR/HSS can register the network by two different wireless access technologies.

In the same way, in a system architecture of the non-integrated HLR/HSS, the UE 10 also can register the network by two different wireless access technologies, and details need not be given.

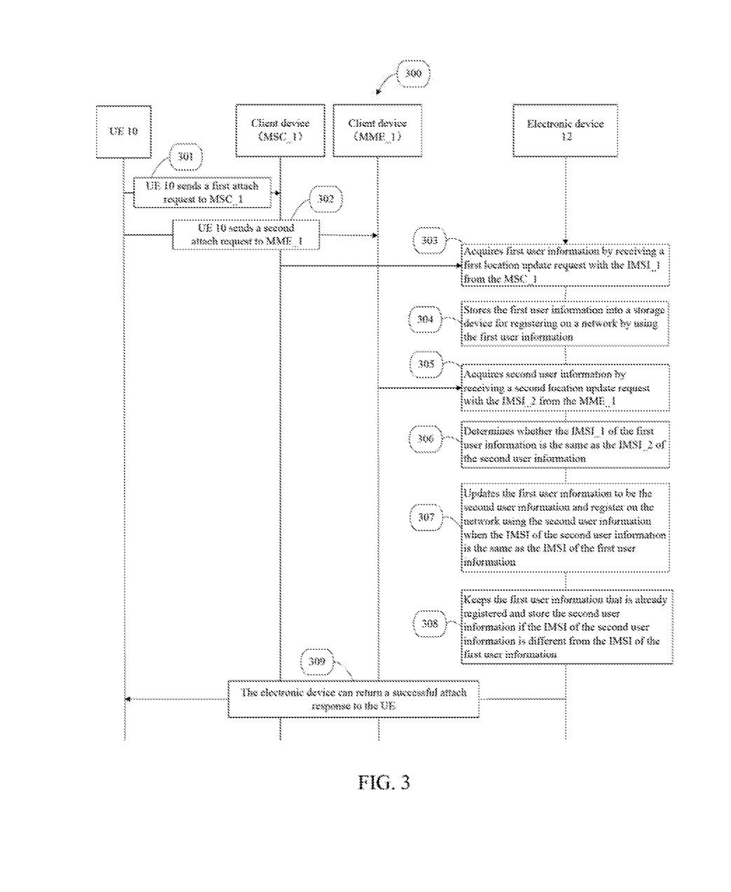

FIG. 3 illustrates a flowchart is presented in accordance with an example embodiment. An example method 300 is provided by way of example, as there are a variety of ways to carry out the method. The example method 300 described below can be carried out using the configurations illustrated in FIG. 1, and various elements of these figures are referenced in explaining the example method. Each block shown in FIG. 3 represents one or more processes, methods, or subroutines, carried out in the example method 300. Furthermore, the illustrated order of blocks is illustrative only and the order of the blocks can be changed according to the present disclosure. The example method 300 can begin at block 301. Depending on the embodiment, additional blocks can be utilized and the ordering of the blocks can be changed.

At block 301, the UE 10 sends a first attach request with an IMSI_1 to the MSC_1. In at least one embodiment, the UE 10 can be a multi-mode single Subscriber Identity Module (SIM) card dual-standby terminal device, or a multi-mode terminal device with a pair of RF transmitters. The UE 10 can include a SIM card or a USIM card. The SIM card can include two IMSI, for example, IMSI_1, and IMSI_2

At block 302, the UE 10 sends a second attach request with an IMSI_2 to the MME_1.

At block 303, the electronic device 12 can acquire first user information by receiving a first location update request with the IMSI_1 from the MSC_1. In at least one embodiment, the first user information can include, but is not limited to, identity attestation number of the user, IMSI, location information, MME number, MSC number, and Access Point Name (APN). The electronic device 12 can be a HLR/HSS.

At block 304, the electronic device 12 can store the first user information into the storage device for registering on a network by using the first user information.

At block 305, the electronic device 12 can acquire second user information by receiving a second location update request with the IMSI_2 from the MME_1. In at least one embodiment, the identity attestation number of the first user information is the same as the second user information.

At block 306, the electronic device 12 can determine whether the IMSI_1 of the first user information is the same as the IMSI_2 of the second user information. When the IMSI_1 of the first user information is the same as the IMSI_2 of the second user information, the procedure goes to block 307. When the IMSI_1 of the first user information is different from the IMSI_2 of the second user information, the procedure goes to block 308.

At block 307, the electronic device 12 can update the first user information to be the second user information and register on the network using the second user information. In at least one embodiment, as shown in FIG. 1, if the UE 10 roams from a service range of the MSC_1 to a service range of the MSC_2, the location information of the second user information is different from the location information of the first user information. Thus, the electronic device 12 can update the first user information to be the second user information and register on the network using the second user information. In detail, the electronic device 12 can de-attach the IMSI_1 of the first user information, and register on the network using the second user information with the IMSI_2.

At block 308, the electronic device 12 can keep the first user information that is already registered and store the second user information, thus the electronic device 12 can register on the network using two radio access technologies at the same time.

At block 309, the electronic device 12 can return a successful attach response to the UE 10.

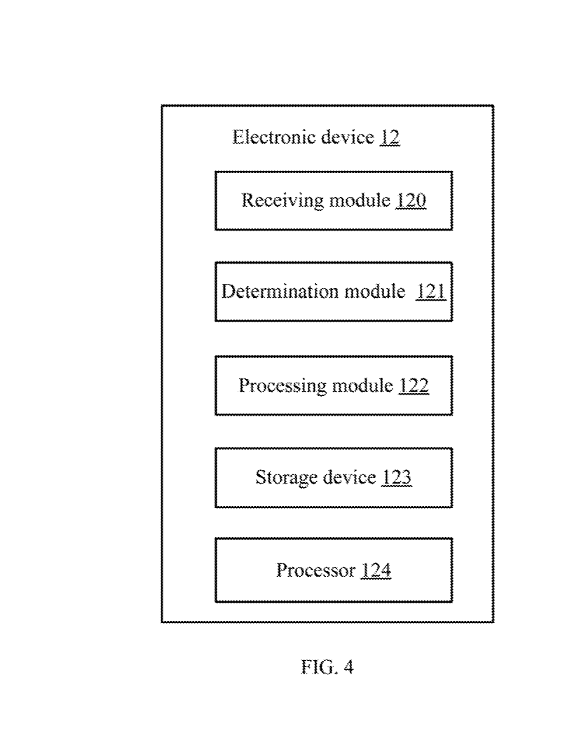

FIG. 4 is a block diagram of an example embodiment of an electronic device. In at least one embodiment as shown in FIG. 4, the electronic device 12 includes, but is not limited to, a receiving module 120, a determination module 121, a processing module 122, a storage device 123, and at least one processor 124. In at least one embodiment, the modules 120, 121, and 122 can include computerized codes in the form of one or more programs which are stored in the storage device 123. The at least one processor 124 executes the computerized codes to provide functions of the modules 120-122.

In at least one embodiment, the receiving module 120 can receive a location update request from the client device 11. For example, the receiving module 120 can receive a first location update request from a first client device for acquiring first user information, and store the first user information for registering network. The receiving module 120 can receive a second location update request from a second client device for acquiring second user information. In at least one embodiment, the first client device can be a MSC, and the second client device can be a MME. The user information include, but not limit to, identity attestation number of the user, IMSI, location information, MME number, MSC number, Access Point Name (APN).

In at least one embodiment, the determination module 121 can determine whether an IMSI of the second user information is the same as an IMSI of the first user information.

In at least one embodiment, the processing module 122 can update the first user information to be the second user information when the IMSI of the second user information is the same as the IMSI of the first user information. In at least one embodiment, the electronic device can de-attach the IMSI_1 of the first user information, and register the network using the second user information with the IMSI_2.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A communication system comprising:
a first client device, configured to receive a first attach request from a user equipment and to send a first location update request in response to the first attach request;
a second client device, configured to receive a second attach request from the user equipment and to send a second location update request in response to the second attach request; and
an electronic device, being connected to the first and second client devices and configured to receive the first location update request from the first client device and to receive the second location update request from the second client device; wherein
the electronic device acquires first user information from the first location update request and stores the first user information;
the electronic device acquires second user information from the second location update request; and
the electronic device keeps the first user information that is already registered and stores the second user information into a storage device of the electronic device if an International Mobile Subscriber Identification (IMSI) of the second user information is different from an IMSI of the first user information.

2. The communication system according to claim 1, wherein the electronic device updates the first user information to be the second user information if the IMSI of the second user information is the same as the IMSI of the first user information.

3. The communication system according to claim 1, wherein the first client device is a Mobile Switching Center (MSC), and the second client device is a Mobile Management Entity (MME).

4. The communication system according to claim 1, wherein the user equipment is a multi-mode single Subscriber Identity Module (SIM) card dual-standby terminal device, or a multi-mode terminal device with a pair of Radio Frequency (RF) transmitters.

5. The communication system according to claim 4, wherein a SIM card of the user equipment comprising two IMSI.

6. An electronic device comprising:
at least one processor; and
a storage device, wherein the storage device stores one or more programs that, when executed by the at least one processor, cause the at least one processor to:
acquire first user information from a first location update request after receiving the first location update request from a first client device;
store the first user information into the storage device and register on a network by using the first user information;
acquire second user information from a second location update request after receiving the second location update request from a second client device;
determine whether an IMSI of the second user information is the same as an IMSI of the first user information; and
keep the first user information that is already registered and store the second user information into the storage device if the IMSI of the second user information is different from the IMSI of the first user information.

7. The electronic device according to claim 6, wherein the programs further cause the at least one processor to:
update the first user information to be the second user information to register on a network by using the second user information if the IMSI of the second user information is the same as the IMSI of the first user information.

8. The electronic device according to claim 6, wherein the first client device is MSC, and the second client device is MME.

9. A registering method comprising:
acquiring, at an electronic device, first user information when receiving a first location update request from a first client device, wherein the first location update request is in response to a first attach request from a user equipment;
storing, at the electronic device, the first user information into a storage device of the electronic device and register on a network by using the first user information;
acquiring, at the electronic device, second user information when receiving a second location update request from a second client device, wherein the second location update request is in response to a second attach request from the user equipment;
determining, at the electronic device, whether an IMSI of the second user information is the same as an IMSI of the first user information;
keeping, at the electronic device, the first user information that is already registered; and
storing, at the electronic device, the second user information into the storage device if the IMSI of the second user information is different from the IMSI of the first user information.

10. The method according to claim 9, further comprising:
updating, at the electronic device, the first user information to be the second user information to register on a network by using the second user information if the IMSI of the second user information is the same as the IMSI of the first user information.

11. The method according to claim 9, wherein the first client device is MSC, and the second client device is MME

12. The method according to claim 9, wherein the user equipment is a multi-mode single Subscriber Identity Module SIM card dual-standby terminal device, or a multi-mode terminal device with a pair of Radio Frequency RF transmitters.

13. The method according to claim 12, wherein a SIM card of the user equipment comprising two IMSI.
